(19) United States
(12) Patent Application Publication
(10) Pub. No.: US 2009/0241674 A1
(43) Pub. Date: Oct. 1, 2009

(54) ROTARY MACHINE

(75) Inventors: Tomonaga OYAMADA, Ishioka (JP); Youichi INOUE, Nagahama (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/411,483

(22) Filed: Mar. 26, 2009

(30) Foreign Application Priority Data
Mar. 31, 2008 (JP) 2008-089159

(51) Int. Cl. G01B 17/02; G01L 3/04

(52) U.S. Cl. 73/627; 73/862.191

(57) ABSTRACT

The present invention aims to obtain a rotary machine having a function to stably measure an amount of wear of a sliding surface in a sliding bearing with a high degree of accuracy. The present invention provides a rotary machine including: a shaft rotated by torque transmitted from a driving source; a bearing for supporting the shaft; an oil film portion formed between the shaft and the bearing; an ultrasound sensor to propagate an ultrasound pulse toward the sliding surface or the reference step surface provided opposite to the ultrasound sensor installation surface and to receive the ultrasound pulse reflected by the oil film portion; and a diagnostic unit to drive the ultrasound sensor to compare a prestored intensity of the ultrasound pulse in the oil film portion and an intensity of the ultrasound pulse reflected by the oil film portion.

### CROSS REFERENCE TO RELATED APPLICATIONS

The present application claims benefit of the filing date of Japanese Patent Application No. 2008-089159 filed on Mar. 31, 2008 which is incorporated herein by reference.

### FIELD OF THE INVENTION

The present invention relates to a rotary machine having a shaft rotated by torque of a driving source, and a bearing which slidably supports the shaft via an oil film.

### DESCRIPTION OF THE RELATED ART

Heretofore, in a technique for diagnosis of an amount of wear of the bearing of the rotary machine using ultrasound, an ultrasound sensor is mounted on an outer surface of the bearing to calculate a change in thickness of the bearing member based on reflection times at an outer surface and an inner surface of the bearing. See JP 05-034135 A. In this measurement technique, the ultrasound sensor is mounted on the outer surface of the bearing, an ultrasound pulse is made to propagate toward the bearing, the ultrasound pulse arrives at and is reflected by the outer surface and the inner surface of the bearing, the ultrasound sensor receives the reflected pulse signals, and a thickness of the bearing is calculated based on a time interval between the two reflected pulse signals.

However, in the prior art described above, it is essential for a measurement equipment to separate the two reflected pulse signals on a time axis to measure the time interval with a high degree of accuracy. And in a measurement of a small change in thickness of the bearing, which is equal to or less than 50 micrometers and is caused by wearing, using sound wave having high propagation speed, a measurement error in thickness of the bearing tends to increase because of a low time resolution of the measurement equipment, and a recognition error of the reflected pulse signals, etc. For this reason, even if the rotary machine is loaded with an apparatus for measuring an amount of wear using the prior art method, it is difficult to measure the amount of wear, which is equal to or less than 50 micrometers, to early predict the time for the bearing to be changed, because the measurable amount of wear closes to the amount of wear which requires a bearing to be changed.

Also, JP 2001-141617 A describes a method and an apparatus in which a blind hole is formed on a sliding member, and ultrasound sensors are mounted on a sliding surface and a back surface of the blind hole to simultaneously send ultrasound toward each surface. And an interference between two reflected ultrasound waves reflected by the sliding surface and a bottom of the blind hole is measured to calculate an amount of wear. In this measuring method, an area of the sliding surface, which is an object to be measured and by which the ultrasound is reflected, equals to that of the bottom of the blind hole, by which the ultrasound is reflected. And the amount of wear is measured based on a change in an interference state by simultaneously sending and receiving ultrasound between the sliding surface and the bottom of the blind hole, at which a change in depth of the blind hole caused by wearing of the sliding surface mainly effects on the interference state of the ultrasound.

However, in the above prior art, it is necessary to keep an area ratio between the sliding surface, which is the object to be measured, and the bottom of the blind hole, and it is difficult to stably measure a wearing state when the area ratio changes because of deformation of the surface caused by a contact load, damages in the vicinity of the blind hole caused by wearing, or entry of wear particles or foreign matters from the outside into the blind hole, etc.

Therefore, the present invention aims to solve the foregoing problems, and it is an object of the present invention to provide a rotary machine having a function to stably measure an amount of wear of a sliding surface in a sliding bearing with a high degree of accuracy.

### SUMMARY OF THE INVENTION

In order to achieve the above object, the present invention provides a rotary machine including: a shaft rotated by torque transmitted from a driving source; a bearing for supporting the shaft, the bearing including a sliding surface opposite to the shaft, an oil groove provided on the sliding surface to be a channel of a lubricating oil, a reference step surface which communicates with the oil groove and is recessed in the direction to an outer circumference from the sliding surface, and an ultrasound sensor installation surface different from the sliding surface and provided on the outer circumference of the bearing at a location of a normal line of each of the sliding surface and the reference step surface; an oil film portion formed between the shaft and the bearing; an ultrasound sensor to propagate an ultrasound pulse toward the sliding surface or the reference step surface provided opposite to the ultrasound sensor installation surface and to receive the ultrasound pulse reflected by the oil film portion; and a diagnostic unit to drive the ultrasound sensor to compare a prestored intensity of the ultrasound pulse of the oil film portion and an intensity of the ultrasound pulse reflected by the oil film portion.

### BRIEF DESCRIPTION OF THE DRAWINGS

The objects and features of the present invention will become more readily apparent from the following detailed description taken in conjunction with the accompanying drawings in which:

FIG. 1 is a cross-sectional view of a centrifugal compressor having a bearing according to the present invention;

FIG. 2 is a perspective view of a bearing included in the rotary machine according to the present invention;

FIG. 3 is a partial cross-sectional view of a connection between the bearing and a ultrasound sensor, and a propagation path of the ultrasound;

FIG. 4 is a diagram depicting sample screen shots of pulse recognition waveforms at the time when measurements of the reflected ultrasound waves are performed with the ultrasound sensor and the bearing being contacted;

FIG. 5 is a graph showing a relationship between a thickness of an oil film and an intensity of a reflected ultrasound wave prestored in a diagnostic unit;

FIG. 6 is a diagram depicting a measurement example at the time when the wear which does not progress yet is measured using a first method in the rotary machine according to the present invention;

FIG. 7 is a diagram depicting a measurement example at the time when the wear which has already progressed is measured using the first method in the rotary machine according to the present invention;

FIG. 8 is a diagram depicting a measurement example at the time when the intensity of the reflected wave is measured to obtain a reference value using a second method in the rotary machine according to the present invention;

FIG. 9 is a diagram depicting a measurement example at the time when the intensity of the reflected wave is measured to obtain a difference in thickness of the oil films using the second method in the rotary machine according to the present invention;

FIG. 10 is a partial cross-sectional view of a structure in which the ultrasound sensor is fixed to each of the ultrasound sensor installation surfaces with a jig; and

FIG. 11 is a partial cross-sectional view of a structure in which the ultrasound sensor is connected to the ultrasound sensor installation surface via an ultrasound medium.

### DETAILED DESCRIPTION OF THE INVENTION

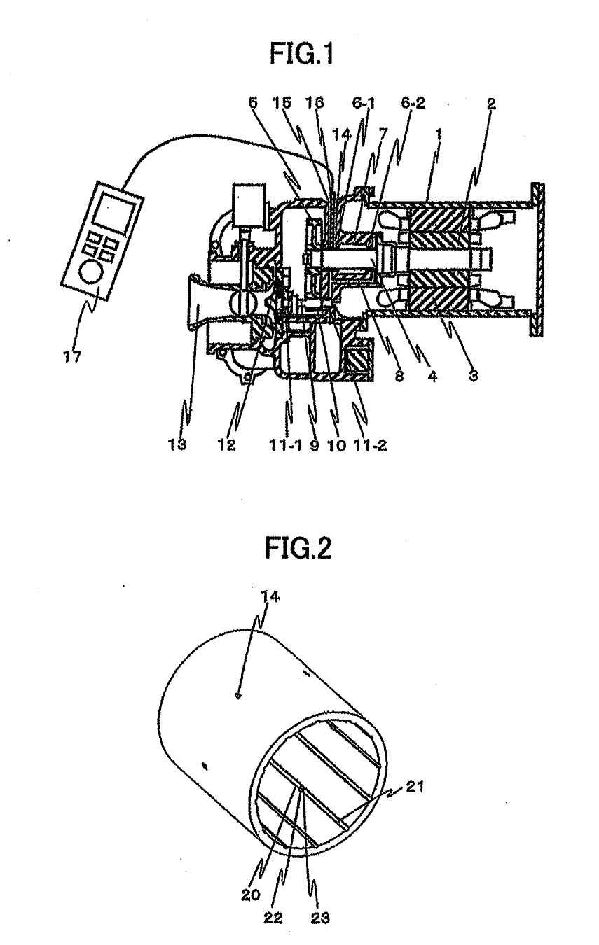

Hereinafter, embodiments of the present invention will be explained with reference to FIGS. 1-11. FIG. 1 is a cross-sectional view of a centrifugal compressor according to the present invention. A driving source 1 is an electric motor, and comprises a rotator 2 and a stator 3. A first shaft 4 is connected directly to a rotator 2, and is engaged with a large gearwheel 5 at the end opposite to the driving source 1. This first shaft 4 is slidably supported by bearings 6-1 and 6-2, and these bearings 6-1 and 6-2 are attached to a bearing supporting frame 7. The bearing supporting frame 7 is provided with a fill opening 8, and a lubricating oil is supplied to each of the bearings through this fill opening 8. A second shaft 9 has a pinion 10 engaged with the large gearwheel 5, and is rotatably supported by bearing portions 11-1 and 11-2. This second shaft 9 is connected to a fan 12, and air drawn through an inlet 13 is compressed by rotating the fan 12. The bearing 6-1 has an ultrasound sensor installation surface 14 at its outer circumference portion, and an ultrasound sensor 16 is removably attached to the ultrasound sensor installation surface 14 through a sensor insertion hole 15 of the bearing supporting frame 7. A diagnostic unit 17 is connected to the ultrasound sensor 16 via electric wires. The diagnostic unit 17 drives the ultrasound sensor 16 to propagate the ultrasound pulse in the bearing 6-1, receives an ultrasound wave reflected by the oil film portion at which the bearing 6-1 slidably supports the first shaft 4 via the oil film of the lubricating oil, measures an intensity of the reflected wave to calculate a thickness of the oil film with reference to a prestored relationship between a thickness of the oil film and an intensity of the reflected ultrasound wave, and calculates an amount of wear from a plurality of prestored relationships to display and output the amount.

FIG. 2 is a perspective view of the bearing 6-1. An inner circumference of the cylindrical bearing 6-1 slidably supports the first shaft 4 via the oil film. A sliding surface 20 which is the most inner surface and an object to be measured of the amount of wear, an oil groove 21 which is recessed in the direction to an outer circumference from the sliding surface 20 and is a supplying channel of the lubricating oil, and a reference step surface 22 which is recessed in the direction to the outer circumference from the sliding surface 20 and communicates with the oil groove 21 are provided on the inner circumference, and a correction step surface 23 is provided within the oil groove 21. An ultrasound sensor installation surface 14 is provided on an outer circumference portion of the bearing in a direction of a normal line of each of the sliding surface 20, the reference step surface 22, and the correction step surface 23. The ultrasound sensor installation surface 14 includes a plurality of surfaces, and each of the sliding surface 20, the reference step surface 22, and the correction step surface 23 exists on inner side of each of the surfaces.

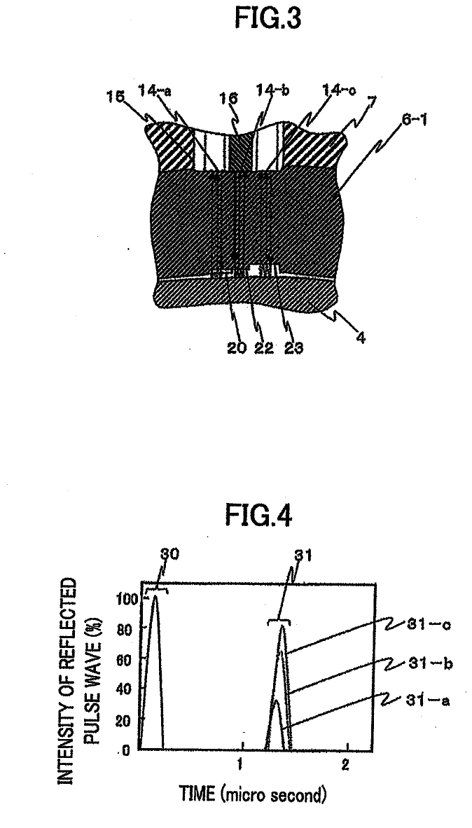

FIG. 3 is a partial cross-sectional view of a connection between the bearing 6-1 and the ultrasound sensor 16. With this drawing, a positional relationship among the sliding surface 20, the reference step surface 22, the correction step surface 23, the ultrasound sensor installation surface 14, and the ultrasound sensor 16, and a propagation path of the ultrasound will be explained. Ultrasound sensor installation surfaces 14-a, 14-b, and 14-c are provided on the outer circumference portion of the bearing 6-1, and the sliding surface 20 and the ultrasound sensor installation surface 14-a, the reference step surface 22 and the ultrasound sensor installation surface 14-b, and the correction step surface 23 and the ultrasound sensor installation surface 14-c share normal lines respectively. Every detachable ultrasound sensor 16 is attached to each of the step surfaces in turn so as to propagate the ultrasound pulse in the bearing 6-1, to receive each of pulses reflected by the oil film portion between the sliding surface 20 and the first shaft 4, the oil film portion between the reference step surface 22 and the first shaft 4, and the oil film portion between the correction step surface 23 and the first shaft 4, and to measure each of intensities of the pulses.

The measurement of pulses reflected by the oil film portion on the sliding surface 20, the oil film portion on the reference step surface 22, and the oil film portion on the correction step surface 23 should be performed under conditions where other factors than thickness of the oil film, which change the intensity of the reflected ultrasound wave, such as a propagation distance of the ultrasound, a configuration of the oil film portion surface, and a contact state between the ultrasound sensor 16 and each of the ultrasound sensor installation surfaces are equal at the time of measurement of each of the oil film portions. In this embodiment, provided that a distance between the sliding surface and the ultrasound sensor installation surface 14-a, a distance between the reference step surface 22 and the ultrasound sensor installation surface 14-b, and a distance between the correction step surface 23 and the ultrasound sensor installation surface 14-c differ by only step differences among the surfaces, the propagation distance of the ultrasound propagated in the bearing 6-1 is controlled to suppress an effect on the intensity of the reflected wave due to difference in attenuations of the ultrasounds caused by difference in the propagation distances. With respect to the difference in attenuations of the ultrasounds caused by difference in the propagation distances of the ultrasounds, after measurement of the reflected waves, corrections may be performed in consideration of attenuations caused by difference in the propagation distances to use the corrected values in diagnosis. However, in this embodiment, it is possible to improve measurement accuracy by equalizing the propagation distances in advance. Likewise, in difference of configurations among the sliding surface 20, the reference step surface 22, and the correction step surface 23, after measurement of the reflected waves, corrections may be performed in consideration of attenuations caused by difference in configurations of the surfaces to use the corrected values in diagnosis. However, in this embodiment, as each surface has the same configuration as that of the sliding surface, each surface preferably has the same characteristics as those of the sliding surface in consideration of an effect on an ultrasound reflection in a measurement range of the ultrasound. Also, the ultrasound sensor 16 is connected to the ultrasound sensor installation surface 14 via an elastic body or a viscous material, and is evenly pressed against each of the ultrasound sensor installation surfaces 14-a, 14-b, and 14-c to suppress a variance in measurements caused by a contact state between the ultrasound sensor 16 and each of the ultrasound sensor installation surfaces 14.

FIG. 4 is a diagram depicting sample screen shots of pulse recognition waveforms at the time when measurements of the reflected ultrasound waves are performed at each of the oil film portions. First, the ultrasound sensor 16 is connected to the ultrasound sensor installation surface 14-a. When a pulsed ultrasound incident wave 30 is propagated into the bearing 6-1, a reflected wave reflected by the oil film portion on the sliding surface 20 is received by the ultrasound sensor 16 again, and is measured as a reflected wave 31-a. Next, the ultrasound sensor 16 is connected to the ultrasound sensor installation surface 14-b. When the incident wave 30 is propagated into the bearing 6-1, a reflected wave reflected by the oil film portion on the reference step surface 22 is received by the ultrasound sensor 16 again, and is measured as a reflected wave 31-b. Likewise, the ultrasound sensor 16 is connected to the ultrasound sensor installation surface 14-c. When the incident wave 30 is propagated into the bearing 6-1, a reflected wave reflected by the oil film portion on the correction step surface 23 is received by the ultrasound sensor 16, and is measured as a reflected wave 31-c. In this embodiment, an initial step difference between the sliding surface 20 and the reference step surface 22 is set to 50 micrometers, and an initial step difference between the sliding surface 20 and the correction step surface 23 is set to 100 micrometers. Therefore, it is supposed that the maximum difference between the oil film portion on the sliding surface 20 and the oil film portion on the reference step surface 22 is 50 micrometers, and the maximum difference between the oil film portion on the sliding surface 20 and the oil film portion on the correction step surface 23 is 100 micrometers. When the measurement frequency is fixed, an intensity of each of the reflected waves increases or decreases according to a thickness of the oil film on each of the oil film portions, which is the object to be measured. Therefore, due to the above step differences, the intensities of the reflected waves are ordered in descending order as follows: the reflected wave 31-c, the reflected wave 31-b, and the reflected wave 31-a. Compared with the bearing used in this embodiment, dimensions of the above step differences are less than 1/30 of dimension of the bearing. Therefore, three reflected pulse waves on the screen are measured at almost the same position on the time axis, and the differences in attenuations of the ultrasounds caused by differences in the propagation distances in the bearing are considered to be small at the same level as the above comparison.

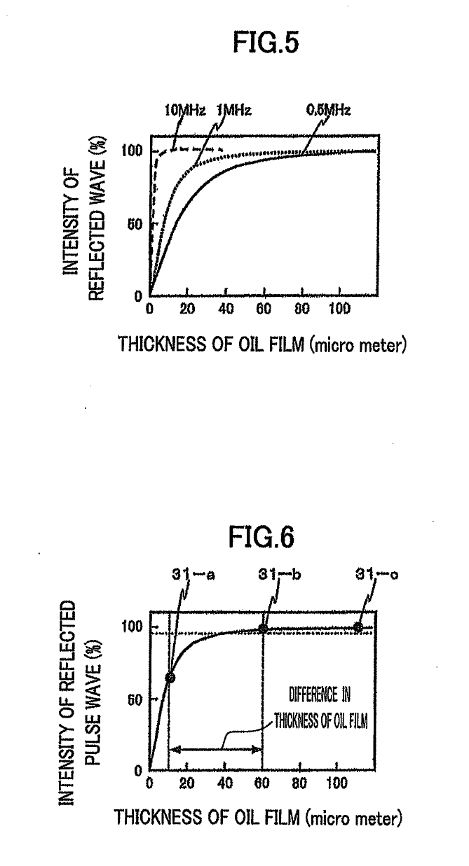

FIG. 5 is a graph showing a relationship of the thickness of the oil film between the bearing and the shaft relative to the intensity of the reflected ultrasound wave. The relationship is prestored in the diagnostic unit 17. An intensity I of the reflected pulse wave is expressed by equations 1 and 2 in units of percentage. In the diagnostic unit 17, acoustic impedances, an acoustic velocity, and correction coefficients are changed depending on various conditions such as a temperature, and a type of oil, etc. set by a setting circuit incorporated in the diagnostic unit 17, and the relationship between the thickness of the oil film and the intensity of the reflected ultrasound wave is referred to in accordance with a state of the rotary machine.

$$I = \sqrt{\frac{{( \frac{{Z}_{1}}{{Z}_{3}} - 1 )}^{2} \times {( \frac{{Z}_{1}}{{Z}_{2}} - \frac{{Z}_{2}}{{Z}_{3}} )}^{2} {tan}^{2} {θ}_{2}}{{( \frac{{Z}_{1}}{{Z}_{3}} + 1 )}^{2} \times {( \frac{{Z}_{1}}{{Z}_{2}} + \frac{{Z}_{2}}{{Z}_{3}} )}^{2} {tan}^{2} {θ}_{2}}}$$

$${θ}_{2} = {( A \times \frac{2 π h}{{c}_{2}} )}^{B}$$

where, I is the intensity of the reflected pulse wave, Z₁ is an acoustic impedance of the bearing, Z₂ is an acoustic impedance of the oil film, Z₃ is an acoustic impedance of the shaft, h is a thickness of the oil film, c₂ is an acoustic velocity in the oil film, f is a frequency of the ultrasound, and A, B are correction coefficients.

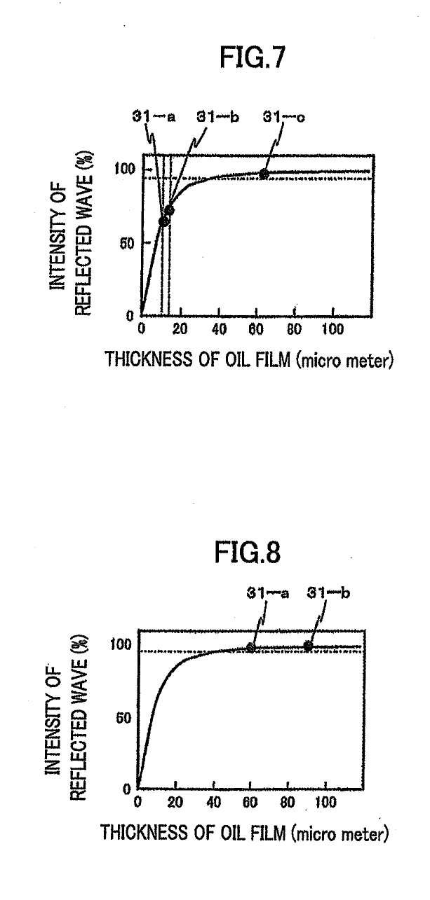

With reference to FIGS. 6 and 7, a first method for diagnosis of an amount of wear based on the intensity of the reflected wave will be explained. FIG. 6 is a diagram depicting a measurement example at the time when the wear does not progress yet. FIG. 7 is a diagram depicting a measurement example at the time when the wear has already progressed. First, an operating condition of the rotary machine is adjusted while a measurement of the ultrasound is performed. As shown in FIG. 6, the thickness of the oil film is controlled such that the intensities are ordered in descending order as follows: the intensity of the reflected wave 31-c from the oil film portion on the correction step surface 23, the intensity of the reflected wave 31-b from the oil film portion on the reference step surface 22, and the intensity of the reflected wave 31-a from the oil film portion on the sliding surface 20. The intensity of the reflected wave 31-a and the intensity of the reflected wave 31-b are divided by the intensity of the reflected wave 31-c to be normalized. With reference to the relationship between the thickness of the oil film prestored and the intensity of the reflected ultrasound wave in the diagnostic unit 17, the difference in the thickness of the oil film between the oil film portion on the sliding surface 20 and the oil film portion on the reference step surface 22 can be calculated. As the wear of the sliding surface 20 progresses, the step difference between the sliding surface 20 and the reference step surface 22 decreases. Therefore, as shown in FIG. 7, when measurements of reflected ultrasound waves are performed likewise, the difference between the thicknesses of the oil films indicated by the reflected wave 31-a and the reflected wave 31-b decreases. As described above, the increase in the amount of the wear caused by the progress of the wear of the sliding surface 20 changes in response to the difference in the thickness of the oil film between the oil film portion on the sliding surface 20 and the oil film portion on the reference step surface 22. Therefore, using the above described relationship, it is possible to diagnose the amount of wear of the sliding surface 20.

As described above, the intensity of the reflected wave 31-c at the oil film portion on the correction step surface 23 is used as a reference value to correct the intensities of other reflected waves. Therefore, in the measurement range, it is desirable to keep the intensity of the reflected wave 31-c at a constant value regardless of a change in the thickness of the oil film. However, in the actual measurement of the intensity of the reflected wave, it has been found that the intensity of the reflected wave has a variance up to 5% due to a recognition accuracy of the pulsed reflected wave. In this embodiment, at the time of measurement, the thickness of the oil film is controlled such that a change in the intensity of the reflected wave 31-c is up to 5% relative to a change in the thickness of the oil film of 50 micrometers.

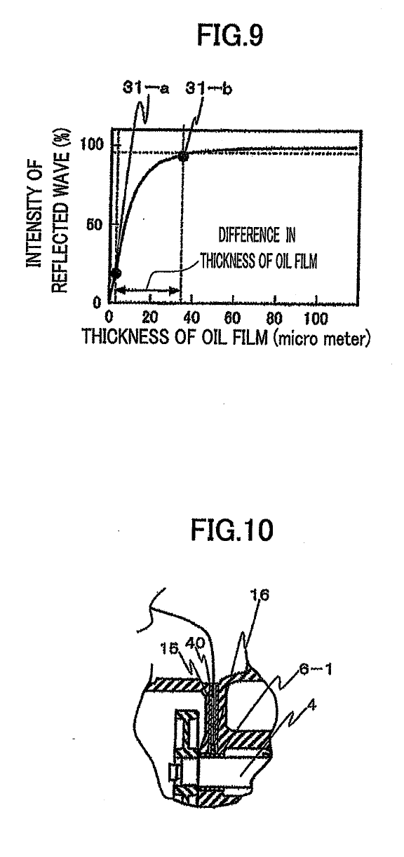

With reference to FIGS. 8 and 9, a second method for diagnosis of an amount of wear based on the intensity of the reflected wave will be explained. First, an operating condition of the rotary machine is adjusted to control the thickness of the oil film on the sliding surface while a measurement of the ultrasound is performed. As shown in FIG. 8, the intensity of the reflected wave 31-b is measured as a reference value in a range of the thickness of the oil film. In the range, a change in the intensity of the reflected wave 31-b from the oil film portion on the reference step surface 22 is up to 5% even if the thickness of the oil film is changed by the amount of wear of the object to be measured. Next, as shown in FIG. 9, an operating condition of the rotary machine is adjusted to control the thickness of the oil film on the sliding surface such that the intensities are ordered in descending order as follows: the intensity of the reflected wave 31-b from the oil film portion on the reference step surface 22, and the intensity of the reflected wave 31-a from the oil film portion on the sliding surface 20, and such that the intensity of the reflected wave 31-b is up to the above reference value. The intensity of the reflected wave 31-a and the intensity of the reflected wave 31-b are divided by the reference value to be normalized. With reference to the relationship between the thickness of the oil film and the intensity of the reflected ultrasound wave prestored in the diagnostic unit 17, the difference in the thickness of the oil film between the oil film portion on the sliding surface 20 and the oil film portion on the reference step surface 22 can be calculated. As the wear of the sliding surface 20 progresses, the step difference between the sliding surface 20 and the reference step surface 22 decreases. The difference in the thickness of the oil film indicated by the reflected wave 31-a and the reflected wave 31-b decreases. As described above, the increase in the amount of the wear caused by the progress of the wear of the sliding surface 20 corresponds to the difference in the thickness of the oil film between the oil film portion on the sliding surface 20 and the oil film portion on the reference step surface 22. Therefore, using the above described relationship, it is possible to diagnose the amount of wear of the sliding surface 20. Even if the operating condition of the rotary machine is adjusted many times at the time of measurement, the second method has the advantage of simplified structure of the bearing because only the reference step surface can be provided on the inner surface of the bearing.

Also, in the diagnostic unit 17 of this embodiment, it is possible to alternately change the first and second methods for diagnosis of the amount of wear. As described above, in the method using the intensity of the reflected ultrasound wave, the measurement range for the amount of wear of the sliding surface 20 is set to 50 micrometers. Therefore, when the amount of wear is more than 50 micrometers, it is also possible to diagnose the amount of wear by converting a change in the thickness of the bearing 6-1 to the amount of wear. The thickness of the bearing 6-1 is calculated by a time interval from the time at which the ultrasound sensor 16 propagates the ultrasound pulse in the bearing 6-1 to the time at which the reflected wave reflected by the sliding surface 20 is received by the ultrasound sensor 16 again (i.e., the time interval between the incident wave 30 and the reflected wave 31-a in FIG. 4).

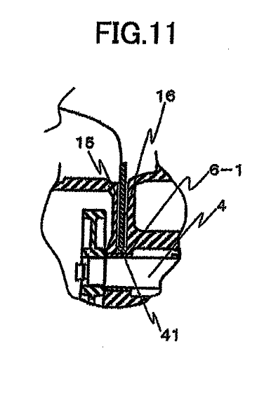

In FIG. 1, the ultrasound sensor 16, which has long rod-like configuration and has a sensor portion at its end, is inserted into the sensor insertion hole 15. The ultrasound sensor 16 is removably connected to each of the ultrasound sensor installation surfaces 14-a, 14-b, and 14-c corresponding to the object surface to be measured to perform the measurement. However, as shown in FIG. 10, the ultrasound sensor 16 may be fixed to each of the ultrasound sensor installation surfaces 14-a, 14-b, and 14-c with jigs 40. In such a case, because a plurality of the ultrasound sensors are used, the variance of sensitivity among the different ultrasound sensors must be corrected prior to the measurement. However, it is possible to omit the step of removing the ultrasound sensor 16 for every measurement. Further, it is also possible to eliminate variance caused by removing the ultrasound sensor to improve the measurement accuracy. Also, as shown in FIG. 11, the ultrasound sensor 16 may be connected to the ultrasound sensor installation surface 14 via an ultrasound medium 41 made of a viscous material, or an elastic body, etc. In such a structure, if enough intensity of the ultrasound reflected wave is ensured, it is possible to remove a partial interspace remained between the ultrasound sensor 16 and the ultrasound sensor installation surface 14 by the viscous material, or the elastic body, etc. to stably measure the reflected ultrasound wave. Further, it is also possible to eliminate the need to directly contact the ultrasound sensor 16 with the outer circumference surface of the bearing 6-1.

While one embodiment of the present invention, i.e., the centrifugal compressor has been described, it will be apparent to a person skilled in the art that the present invention can be applied to other type of a compressor, a pump, or an engine, etc. when each of those has a bearing including a driving source, a shaft, and a lubricating oil.

First, in accordance with the embodiment described above, the rotary machine is operated under a given condition, and the space among the sliding surface, the reference step surface, and the shaft in the bearing is filled with the lubricating oil to form the oil film. Next, the ultrasound sensor is connected to the ultrasound sensor installation surface corresponding to the object surface to be measured. The diagnostic unit drives the ultrasound sensor. The ultrasound sensor transmits the ultrasound pulse to the oil film portion on the object surface to be measured via the bearing, and receives the reflected wave from the oil film portion via the bearing. And the diagnostic unit measures the intensity of the reflected wave. The foregoing measurement is performed to both of the oil film portion on the sliding surface and the oil film portion on the reference step surface. The intensity of each reflected wave is converted to the thickness of the oil film at each oil film portion with reference to a relationship between thickness of the oil film and the intensity of the reflected ultrasound wave prestored in the diagnostic unit. As the wear of the sliding surface of the bearing progresses, the difference in thickness of the oil films at oil film portions decreases. Therefore, the decrease in the difference in thickness of the oil films is diagnosed as the amount of wear of the sliding surface to output a result.

In the relationship between the thickness of the oil film portion formed between the shaft and the bearing and the intensity of the ultrasound reflected wave from the oil film portion, there is a range in which as the thickness of the oil film increases, the intensity of the reflected wave increases at a rate suitable for the frequency. Further, there is also another range in which even if the thickness of the oil film increases, the intensity of the reflected wave does not increase. In particular, when the ultrasound having a frequency of 0.1-10 MHz is used and the thickness of the oil film is equal to or less than 50 micrometers, there is a range in which as the thickness of the oil film increases, the intensity of the reflected wave increases. Therefore, when the step difference between the sliding surface and the reference step surface is set to equal to or less than 50 micrometers at the time of measurement and a frequency of the ultrasound is selected from the range of 0.1-10 MHz depending on the amount of wear which is less than the above step difference, it is possible to diagnose the amount of wear, which is equal to or less than 50 micrometers, with a high degree of accuracy.

The reference step surface has a structure to communicate with the oil groove. Therefore, by the lubricating oil flowing through the oil groove, wear particles entered into the reference step surface and foreign matters from outside are washed out to keep cleanliness, thereby enabling a stable measurement for a long time. Also, by forming the reference step surface within the oil groove, the effect of the washing out is improved and a decrease in the area of the sliding surface caused by providing the reference step surface is minimized. Also, the measurement of the intensity of the reflected wave is performed by connecting the ultrasound sensor to the ultrasound sensor installation surface corresponding to the object surface to be measured. Therefore, if the reflected wave from the object surface to be measured can be measured, it is not necessary to keep the relationship between areas of the surfaces constant.

Also, in the rotary machine, the bearing slidably supports the shaft via the oil film of the lubricating oil, and has the oil groove as a channel of the lubricating oil on the sliding surface. Likewise, the bearing has the reference step surface on the sliding surface to communicate with the oil groove and to form a step which is recessed in the direction to the outer circumference of the bearing. Likewise, separated from the reference step surface, the bearing has the correction step surface on the sliding surface to form a step which is more recessed in the direction to the outer circumference of the bearing than the reference step surface, and has the ultrasound sensor installation surface on the outer circumference. The ultrasound sensor installation surface has normal lines shared with the sliding surface, the reference step surface, and the correction step surface respectively. The space between the surface of the shaft and the reference step surface is filled with the lubricating oil with a first distance which is equal to a step difference between the sliding surface and the reference step surface. When the distance between the surface of the shaft and the reference step surface increases to a distance more than the first distance, the intensity of the reflected wave received by the ultrasound sensor mounted on the ultrasound sensor installation surface increases. And, the space between the shaft and any object surface to be measured on the bearing is filled with the lubricating oil with a second distance which is equal to a step difference between the sliding surface and the correction step surface. When the distance between the shaft and any object surface to be measured on the bearing is decreased from the second distance by a given amount of wear within a measurement range, the intensity of the reflected wave received by the ultrasound sensor mounted on the ultrasound sensor installation surface decreases up to 5%. As mentioned above, the object of the present invention is achieved.

First, in accordance with the method described above, the rotary machine is operated under a given condition, and the space among the sliding surface, the reference step surface, the correction step surface, and the shaft in the bearing is filled with the lubricating oil to form the oil film. Next, the ultrasound sensor is connected to the ultrasound sensor installation surface corresponding to the object surface to be measured. The diagnostic unit drives the ultrasound sensor. The ultrasound sensor transmits the ultrasound pulse to the oil film portion on the object surface to be measured via the bearing, and receives the reflected wave from the oil film portion. And the diagnostic unit measures the intensity of the reflected pulse wave. The foregoing measurement is performed to the oil film portion on the sliding surface, the oil film portion on the reference step surface, and the oil film portion on the correction step surface respectively. Next, the intensity of the reflected wave from the oil film portion on the sliding surface and the intensity of the reflected wave from the oil film portion on the reference step surface are divided by the intensity of the reflected wave from the oil film portion on the correction step surface to be normalized. The normalized intensity of each reflected wave is converted to the thickness of the oil film at each oil film portion with reference to a relationship between thickness of the oil film and the intensity of the reflected wave prestored in the diagnostic unit. As the wear of the sliding surface of the bearing progresses, the difference between the thickness of the oil film at the oil film portion on the sliding surface and the thickness of the oil film at the oil film portion on the reference step surface decreases. Therefore, the decrease in the difference in thickness of the oil films is diagnosed as the amount of wear of the sliding surface to output a result.

The step difference between steps is defined such that a change in the intensity of the reflected wave from the oil film portion on the correction step surface is up to 5% relative to a change in the thickness of the oil film corresponding to the amount of wear in the measurement range. Therefore, based on the intensity of the reflected wave from the oil film portion on the correction step surface having an error up to 5%, the intensity of the reflected wave from the oil film portion on the sliding surface and the intensity of the reflected wave from the oil film portion on the reference step surface are normalized respectively, and thereby reduces a variance in measurement error of the difference in thickness of the oil film, such as measurements of the reflected pulse wave caused by difference in sensitivity or mounting state of the ultrasound sensor and the measurement equipment, or attenuations of the ultrasound caused by difference in material of the rotary machine, etc. As a result, the rotary machine allows users to stably measure an amount of wear of a sliding surface in a sliding bearing with a high degree of accuracy.

In order to confirm that the step difference between the sliding surface and the reference step surface is in a range in which as the thickness of the oil film increases, the intensity of the reflected ultrasound wave increases, the following procedures are performed. That is, the space between the shaft and the reference step surface is filled with the lubricating oil with the shaft and the sliding surface being contacted. As a result, it is possible to confirm that the reflected wave from the oil film portion on the reference step surface increases as a distance between the surface of the shaft and the reference step surface increases.

Further, the reference step surface and the correction step surface have structures to communicate with the oil groove. Therefore, by the lubricating oil flowing through the oil groove, wear particles entered into each of the surfaces and foreign matters from outside are washed out to keep cleanliness, thereby enabling a stable measurement for a long time. Also, by forming the reference step surface and the correction step surface within the oil groove, the effect of the washing out is improved and a decrease in the area of the sliding surface caused by providing the reference step surface is minimized.

In accordance with the embodiment, by providing step surfaces on a sliding member of the bearing in the rotary machine to form a structure having each of the ultrasound sensor installation surfaces on the outer circumference corresponding to each of the step surfaces, the amount of wear of the sliding surface can be measured using the fact that the ultrasound is reflected by the oil film portion including two surfaces opposite to each other via the oil film and that the intensity of the ultrasound changes in response to the thickness of the oil film.

Also, when the ultrasound having a frequency of 0.1-10 MHz is reflected by the oil film having a thickness which is equal to or less than 50 micrometers, the amount of wear can be measured with a high degree of accuracy by converting a change in the thickness which is equal to or less than 50 micrometers to the amount of wear using the fact that there is a range in which as the thickness of the oil film increases, the intensity of the reflected wave increases. Therefore, in a standard industrial rotary machine, a wearing state can be known before the amount of wear reaches a value which requires a bearing to be changed, i.e., 50 micrometers. Therefore, it is possible to predict the time for the bearing to be changed before the rotary machine becomes dysfunctional due to the wear. Further, it is possible to stop the rotary machine to maintain it before an abnormality occurs.

Also, the correction step surface is defined such that a change in the intensity of the reflected ultrasound wave is up to 5% even if the thickness of the oil film increases within the measurement range. Therefore, using the intensity of the reflected ultrasound reflected by the oil film portion on the correction step surface, it is possible to normalize the intensity of reflected wave reflected by other surfaces, thereby reduces a variance in measurement error caused by difference in sensitivity or mounting state of the ultrasound sensor and the measurement equipment. As a result, the rotary machine allows users to stably measure an amount of wear with a high degree of accuracy.

Also, the reference step surface and the correction step surface are provided within the oil groove, or communicate with the oil groove. Therefore, by the flow of the lubricating oil, wear particles entered into the reference step surface and foreign matters from outside are washed out to keep cleanliness, thereby enabling a stable measurement for a long time.

What is claimed is:

1. A rotary machine comprising:
a shaft rotated by torque transmitted from a driving source; and
a bearing for supporting the shaft,
the bearing comprising:
a sliding surface opposite to the shaft,
an oil groove provided on the sliding surface to be a channel of a lubricating oil,
a reference step surface which communicates with the oil groove and is recessed in the direction to an outer circumference from the sliding surface, and
an ultrasound sensor installation surface separated from the sliding surface and provided on the outer circumference of the bearing at a location of a normal line of each of the sliding surface and the reference step surface;
an oil film portion formed between the shaft and the bearing;
an ultrasound sensor to transmit an ultrasound pulse to the sliding surface or the reference step surface provided opposite to the ultrasound sensor installation surface and to receive the ultrasound pulse reflected by the oil film portion; and
a diagnostic unit to drive the ultrasound sensor to compare a prestored intensity of the ultrasound pulse in the oil film portion and an intensity of the ultrasound pulse reflected by the oil film portion.

2. The rotary machine according to claim 1, wherein the oil film portion is filled with a lubricating oil, and when a distance between the surface of the shaft and the reference step surface increases, an intensity of a reflected wave received by the ultrasound sensor increases.

3. The rotary machine according to claim 1, wherein the bearing has a correction step surface which communicates with the oil groove on the sliding surface to form a step which is more recessed than the reference step surface, and has the ultrasound sensor installation surface at a location of a normal line of the correction step surface.

4. The rotary machine according to claim 3,
wherein the oil film portion is filled with a lubricating oil,
when a distance between the surface of the shaft and the reference step surface increases to a distance more than a first distance which is equal to a step difference between the sliding surface and the reference step surface, an intensity of a reflected wave received by the ultrasound sensor increases, and
when a distance between the shaft and any object surface to be measured on the bearing is decreased from a second distance which is equal to a step difference between the sliding surface and the correction step surface by a given amount of wear within a measurement range, an intensity of a reflected wave received by the ultrasound sensor decreases up to 5%.

5. The rotary machine according to claim 1, wherein the ultrasound sensor is mechanically fixed to the ultrasound sensor installation surface.

6. The rotary machine according to claim 1, wherein the ultrasound sensor is fixed to the ultrasound sensor installation surface via a viscous material.

7. The rotary machine according to claim 1, wherein the ultrasound sensor is fixed to the ultrasound sensor installation surface via an elastic body.

8. The rotary machine according to claim 2, wherein the ultrasound sensor is mechanically fixed to the ultrasound sensor installation surface.

9. The rotary machine according to claim 2, wherein the ultrasound sensor is fixed to the ultrasound sensor installation surface via a viscous material.

10. The rotary machine according to claim 2, wherein the ultrasound sensor is fixed to the ultrasound sensor installation surface via an elastic body.
